(19) United States
(12) Patent Application Publication
(10) Pub. No.: US 2015/0271118 A1
(43) Pub. Date: Sep. 24, 2015

(54) APPARATUS AND METHOD FOR ACCESSING CONTENT IN AN EMAIL MESSAGE

(71) Applicant: GOLDMARK TECHNOLOGIES LTD., REHOVOT (IL)

(72) Inventors: EDUARD NUDEL, REHOVOT (IL); JOHNATHAN EREZ, GIVATAYIM (IL)

(21) Appl. No.: 14/662,477

(22) Filed: Mar. 19, 2015

Related U.S. Application Data
(60) Provisional application No. 61/955,222, filed on Mar. 19, 2014.
(60) Provisional application No. 62/045,590, filed on Sep. 4, 2014.

(51) Int. Cl. H04L 12/58

(52) U.S. Cl. CPC H04L 51/08

(57) ABSTRACT

Receiving an email message, identifying one or more links or attachments in the received email message, and responsive to opening the email message by a user of an electronic device, displaying two or more thumbnails representing the links or attachments in the received email message, at least one of the two or more thumbnails is associated with a link of the received email message.

### CROSS-REFERENCE TO RELATED APPLICATIONS

This application claims the benefit of priority from U.S. Provisional Patent Application No. 61/955,222, filed Mar. 19, 2014, and U.S. Provisional Patent Application No. 62/045,590, filed Sep. 4, 2014 the disclosures of which are incorporated herein by reference in their entirety.

### FIELD OF THE INVENTION

The invention discloses a method and apparatus of accessing and displaying content of an email message, more specifically attachment and content from links of the email message.

### BACKGROUND

Email messages are the most common manner of digital communication, with more than 100 billion email messages are sent each day, as of 2013. Email messages are more and more popular in the mobile devices, especially smartphones, as smartphone users enjoy the constant access to their email accounts, increase availability, service, efficiency and the like.

Users of email mobile applications spend a lot of time in handing incoming email messages, because of two main reasons—the number of incoming emails and the time required to handle each one. It is desirable to reduce the amount of time required to handle incoming email messages. Many of those time-consuming email messages involve attachments or other content from links. The user of an email mobile application is required to access additional mobile applications such as a browser, twitter, Facebook, news applications, YouTube and the like. Each time, a lot of time is spent before the additional applications are activated and until the relevant content item is displayed.

### SUMMARY

In one aspect of the invention a method is provided of receiving an email message, identifying one or more links or attachments in the received email message, and responsive to opening the email message by a user of an electronic device, displaying two or more thumbnails representing the links or attachments in the received email message, at least one of the two or more thumbnails is associated with a link of the received email message.

In other aspects of the invention, the method further comprises displaying a body of the email message concurrently with displaying the two or more thumbnails. In some cases, the method further comprises displaying the content of the link inside the email client responsive to receiving a predefined display content gesture from the user.

In other aspects of the invention, the method further comprises downloading the content from the links responsive to receiving a predefined display content gesture from the user. In some cases, the two or more thumbnails are displayed in a single row in a thumbnail bar.

In other aspects of the invention, the method further comprises decreasing the size of the thumbnail bar responsive to detecting a decreasing thumbnail bar gesture. In some cases, the method further comprises increasing the size of the thumbnail bar responsive to detecting an increasing thumbnail bar gesture.

In other aspects of the invention, the method further comprises displaying new thumbnails in the thumbnail bar when the user browses the thumbnail bar.

In other aspects of the invention, the method further comprises aggregating content from two or more links of the received email message and displaying the aggregated content from the two or more links in the thumbnail bar.

In other aspects of the invention, at least two of the two or more thumbnails represent two or more content items of a single link.

In other aspects of the invention, at least one of the two or more thumbnails represent content from a link of the received email message and another one of the two or more thumbnails represent content from an attachment of the received email message.

In other aspects of the invention, the method further comprises generating a thumbnail representing a link according to data extracted from the single link.

In other aspects of the invention, the method further simulating browsing into the link in order to obtain the data extracted from the link.

In other aspects of the invention, the thumbnail representing a link is generated in a server that handles the email message. In some cases, the data extracted from the link is downloaded to the server that handles the email message.

In other aspects of the invention, the method further comprises receiving a selection command from the user with regard to one or more of the content items while displaying the received email message. In some cases, the method further comprises performing an action on the selected content items. In some cases, suggesting and displaying a set of actions according to the type of content item and the source of the content item. In some cases, the method further comprises determining that a link represents a content item.

In other aspects of the invention, the method further comprises receiving credentials from the user in order to access content in a web page and display thumbnails of content items from the link after accessing the web page.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 shows a person using an email messaging application according to exemplary embodiments of the invention;

FIG. 2 shows a user interface for handling content received in an email message, according to exemplary embodiments of the disclosed subject matter;

FIG. 3 shows a method for handling a content element received in an email message, according to exemplary cases of the subject matter; and,

FIG. 4 shows a system for handling a content element received in an email message, according to exemplary cases of the subject matter;

FIG. 5 shows a computerized environment for handling email messages, according to exemplary embodiments of the invention;

FIG. 6 shows an email client with content items displayed under the body of the email messages, according to exemplary embodiments of the invention;

FIG. 7A-7B shows an email client with content items browsed by the user, according to exemplary embodiments of the invention;

FIG. 8 shows an email client with selective actions performed on different content items of an email message, according to exemplary embodiments of the invention;

FIG. 9 shows an email server for handling email messages, according to exemplary embodiments of the invention;

FIGS. 10A and 10B show a method for handling email messages, according to exemplary embodiments of the invention.

### DETAILED DESCRIPTION

The invention discloses a computerized system and method for handling an email message associated with a content element. The content element may be an attachment of the received email message or the email message comprises content element which can be a link to an external website, such as a link to a video in YouTube or a document in a cloud storage service such as Dropbox. The method of the subject matter enables the user of an email messaging application to access and view the content element directly from the inbox level, without accessing or opening the email message itself while scrolling the email message in order to view and share the content element. In case the content element is an image stored in a link, the invention brings the content to the user's email application and saves the user's time and effort in using other applications, such as a browser and social network applications. Instead, the invention enables the user to perform a content gesture on the received email message as displayed in the inbox level and then all content elements relevant to the corresponded email will automatically be available to the user to be viewed and perform other actions such as share (to share a photo for example). Content elements may automatically be displayed within the email client application, even if these were originally stored online, for example an image in a social network. The content will be displayed responsive to detection of the user's content gesture. In some cases, the download of a content element from a web server may occur before the user performed the content gesture. Displaying the content element in the designated location within the email client application enables the user to return to the inbox level by a single press on a return icon, to continue performing standard operations in the email environment, such as composing, sending and other native commands.

Prior art systems analyze only a single user's gesture from the inbox level, which opens a menu of actions to be performed on the email message, not on the content elements that may be attachments or a links pointing to a content hat resides in an online website. The invention adds an additional, second, gesture, which enables the user to view and perform actions to content elements by a single action.

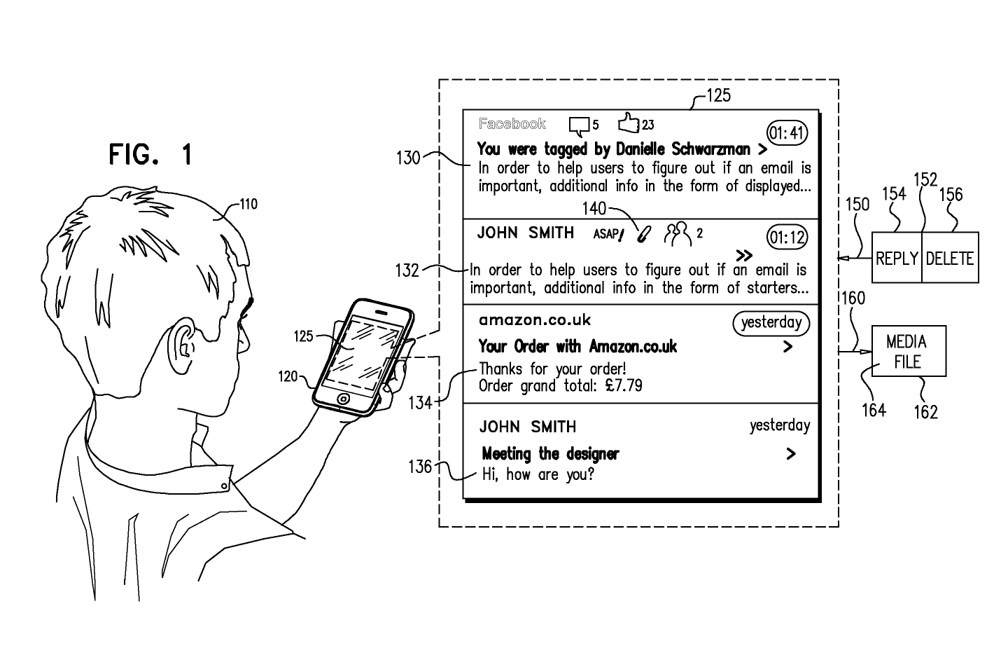

FIG. 1 shows a person using an email messaging application according to exemplary embodiments of the invention. The person 110 holds a personal mobile device 120 in which he manages his email messages. The mobile device 120 comprises a display unit 125 in which a list of email messages is displayed when the person 110 who is the user of the mobile device 120 accesses his email account. The list of email messages in the person's email account may also be referred to as inbox level in which the user can browse between various email messages. The inbox level display in the display unit 125 comprises a plurality of incoming email messages 130, 132, 134, 136. The person 110 may access each email message from the list of incoming email messages, for example by opening the email messages, forward them, delete and the like. The user 110 is provided with some notifications at the inbox level, for example the sender's name, time of arrival of the email message, subject of the email message and whether or not the email message contains additional content elements such as an attachment or a link to a content element stored on a web page. The content element may be a document such as a PDF or Word file, an image, a movie, a link to an image or movie, or a link to an article. The content element may be defined as data other than the simple text inside the email message. For example, in case the received email message comprises a text “Hi, How are you?” and a link to CNN, the link represents a content element. The invention provides a user interface by displaying a content notification 140 that defines a case in which a content element is associated with the received email message 132. In some cases, the content notification 140 is displayed on the inbox level when the received email message 132 comprises an attachment file. In some other cases, the content notification 140 is displayed on the inbox level in case the received email message comprises a link to a content website such as an image stored in a social network page, a folder in an online storage service such as Google Drive, a video in streaming website such as YouTube and the like.

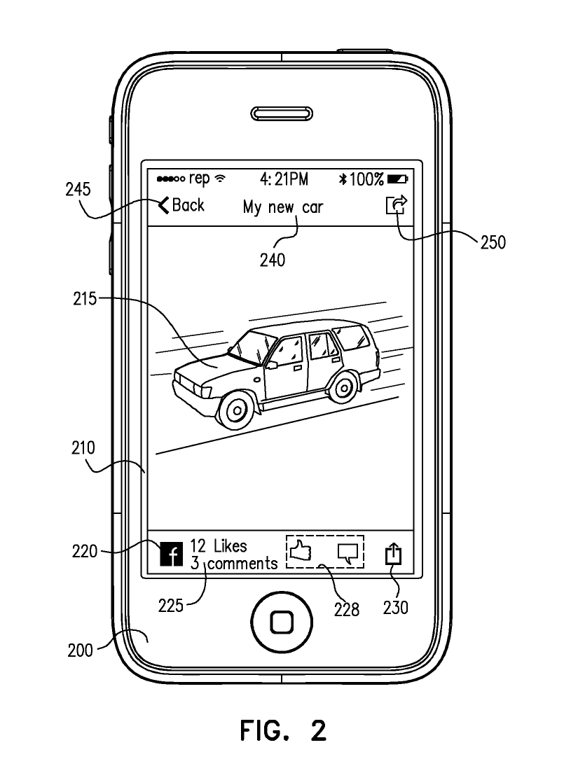

The invention provides a user interface that enables the user 110 to access the content element directly from the inbox level using a content gesture 160 performed on the email message associated with the content element. The content gesture 160 may be performed on a touch screen of the user's device 120. The content gesture 160 may be a swipe gesture 160 from left to right or any other unique gesture. In such a case, the display 162 of the mobile device will display the content element relevant to the email message. The content element 164 will be available to view and the user will be able to perform action on the content element 164 as detailed in FIG. 2. In some cases, the user interface of the invention is configured to detect two gestures—the first gesture 150 from right to left opens a menu 152 with one or more optional commands such as delete 156 and reply 154. The second gesture in such a case is the content gesture 160. In some exemplary cases, the content gesture 160 is accessible from the first gesture 150, as opening the content element is an option displayed on the menu 152 opened when performing the first gesture 150, in addition to known commands such as reply 154 and delete 156. Once activating the content gesture 160 the content element may be automatically displayed, whether the content element is an attachment or a link to a website. In the latter case, content will be displayed without forcing the user to access the source of the content element, i.e. the website where the content element is located, in order for the content element to be displayed. The system can display one or more content elements located inside the email. Upon detection of the content gesture, some elements will be downloaded and displayed automatically while others will be downloaded only when the user will request it. The content element may be an attachment file containing an image, so the image is the content. Using the system of the subject matter, the person 110 does not have to open the email message first, and then scroll down to track down the attachment, tap on the file and wait until the file loads in order to view it. Instead, the user performs the content gesture 160 on the email message that comprises the content and then the image is automatically displayed. In some cases, when content item's size is too big (in term of KBs), whether it's an attachment or a link to a file or a picture that has to be downloaded; only a preview of the content element will be displayed. For example if it's a photo, a small, resized version will be displayed. If it's a document, its header or other metadata will be displayed. User will also have the option to choose whether content element will be downloaded and viewed automatically. For example, when traveling abroad, in roaming mode, files large than 200K will not be downloaded even upon detection of the content gesture. In some other cases, the source of the content element is a web page that stores the content element. In this case, the user does not have to access the web page in order to view the content element. Instead the content element will be displayed within the email application. For example, when a photo album is sent as a link, for example a Picasa album, the content gesture will result in downloading at least a portion of the images in the photo album, and the user will be able to view the images of the photo album in the email application, without accessing the browser and without opening the email message with the link to the photo album.

FIG. 2 shows a user interface for handling a content element received in an email message, according to exemplary embodiments of the disclosed subject matter. The user interface enables a user of an email client application to view and optionally interact with the content element within the email client application with a single gesture made from the inbox level, without the need to open the email message and then open each link or attachment separately. The user interface is displayed on a display unit 210 of a user's device 200. The user's device 200 may be a mobile phone, a tablet computer, a personal computer a laptop and the like.

The user interface comprises a content area 215 in which the content element associated with the received email message is displayed. The content displayed in the content area 215 may be an image, a video, a textual document and the like. In some exemplary cases, the system of the subject matter resizes the image to fit to the content area 215.

The user interface may also comprise a metadata area that comprises metadata of the content element. The metadata may be an icon representing the logo of the website 220 of the content element, for example in case the image was part of an email message containing a link to a photo album of Flickr, the user interface will display an icon 220 associated with the source, Flickr. The metadata may be social metadata 225, such as number of likes, comments, shares of an image or a post, viewers of a video in YouTube and the like.

The user interface may also comprise a feedback area 228 allowing the user to input a feedback or an action which is relevant to the displayed content, whenever possible. The feedback may be a “like” feedback, a “dislike” feedback or a textual feedback enabled by opening a text box at the user interface. The feedback is later transmitted to the source of the email associated with the content, along with identifiers relevant to the content and to the account from which the feedback was sent. The user interface also comprises an action area 230 that activates a native menu for performing actions on the content element inside the user's device 200. Such actions can be sharing, printing, storing and the like. The actions enabled by the action area 230 can also include a native menu as defined by the user's device, and enables actions such as printing the content, saving the content, forwarding the content and the like. The actions area 230 allows for operations on the content, not on the entire email message.

The user interface also comprises a header 240 which is a title of the content, for example the name of the attachment file from which the content was extracted or the URL link. The user interface also comprises a back icon 245 which enables the user to return directly to the inbox level from the content display. The back icon is novel by allowing direct connection from the content display to the inbox level display, as opposed to prior art systems in which the user is only allowed to switch from content display to email display, not back to a list of emails. As the essence of the email message is the content element, the user only wishes to view the content element, and not necessarily the body of the email. As such, the user is enabled to access the content and return to the inbox level in order to handle other incoming email messages. The user interface also comprises an email actions area 250 which enables the user to perform actions on the entire email message, such as forward, delete, reply and the like. The email actions area 250 is novel as prior art user interfaces do not enable performing any operations on the email client when the user views a content element, i.e. an attachment or a content element from a link.

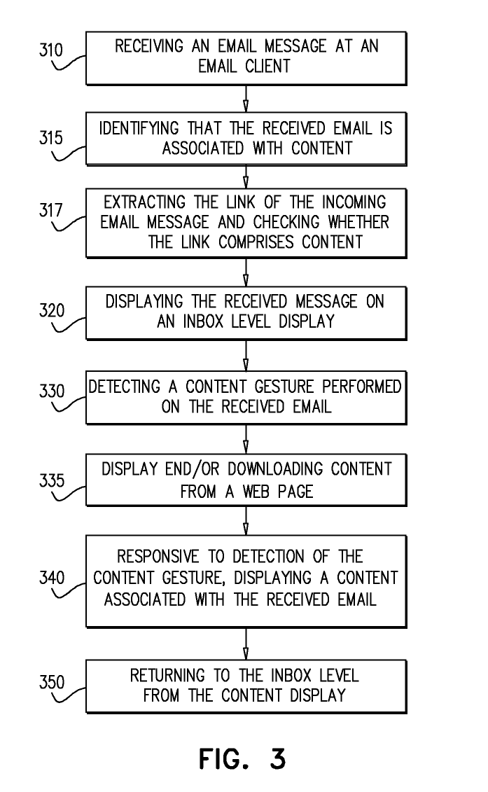

FIG. 3 shows a method for handling a content element received in an email message, according to exemplary cases of the subject matter. The method comprises receiving an incoming email message at an email client 310, for example at the user's device 200. The method also comprises identifying that the incoming email message is associated with the content element 315. Such identification may be achieved when the incoming email message contains an attachment file, in a data field indicating that an attachment is included in the incoming email message. In another case, the incoming email message comprises a link to a website, such as a link to an image or a video, the method extracts the link and checks whether the link comprises content 317. In some exemplary cases, identification of the content element also comprises extracting metadata of the content element, such as number of attachments, number of images in a link to a photo album, size of content, type of content and the like.

Then, the incoming email message is displayed 320 in the inbox level of the email client application. In some cases, when the incoming email message is identified to be associated with a content element, a content notification is displayed 325 on the inbox level, informing the user viewing the email account that the incoming email message is associated with the content element. Such content notification raises the user's attention to the possibility of performing a content gesture in order to view the content element associated with the incoming email message, without opening the incoming email message and without accessing the content. When the user wishes to view the content associated with the incoming email message, the user performs the content gesture from the inbox level. Then, the content gesture is detected 330. Responsive to detection of the content gesture, the content is displayed 340. The content may be displayed in the user interface disclosed in FIG. 2. In some exemplary cases, the content is fetched from a web page 335 in order to be displayed for the user. Fetching the content from the web page may be performed in case the incoming email message comprises a link to a content element, such as a link to a video file in YouTube, a photo in a social network or to a folder in a cloud storage service. Fetching the content element may be performed by streaming a movie from YouTube, downloading images from Picasa, downloading attachments, browsing in a folder of documents in Dropbox and the like. The user may then perform a gesture or a tap on a back icon 245. In such a case, the system of the subject matter returns to the inbox level from the content display 350.

In some exemplary cases, the content element is displayed in the user interface disclosed in FIG. 2. In some other cases, the content element is displayed in the incoming email message upon detection of the content gesture. In the latter case, the incoming email message is opened in two configurations—1. Without the content element in case the user taps on the email at the inbox level. 2. With the content element in case the user performs the content gesture and the content element is fetched and displayed inside the incoming email message, for example below the body of the email message.

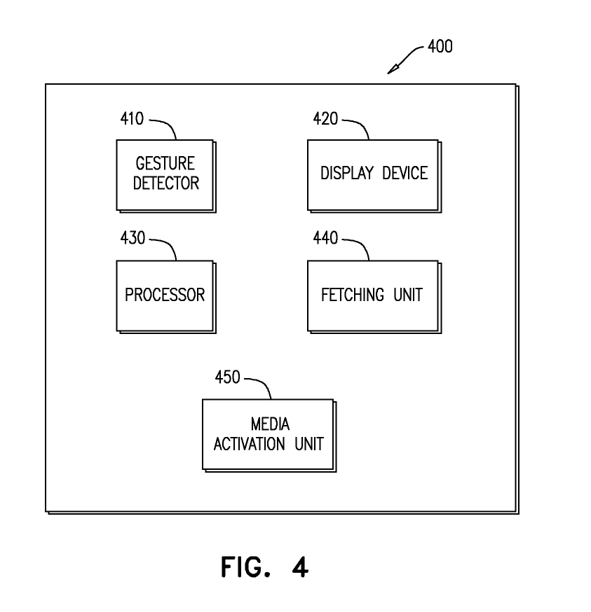

FIG. 4 shows a system for handling a content element received in an email message, according to exemplary cases of the subject matter. The system 400 comprises gesture detector 410 for detecting gestures performed on a display device 420. Such gestures may be content gesture or a first gesture 150. The gestures result in displaying the content element on the display device 420 without accessing the email message associated with the content element and without accessing another mobile application external to the email client application.

The system 400 also comprises a processor 430 for controlling the process of displaying the content element responsive to the content gesture. The processor 430 identifies the gesture and determines that the gesture is a content gesture, for example according to a predefined set of rules stored in a storage of the system 400. The processor 430 also determines how to handle the content element responsive to detection of the content gesture, for example according to content element type, or whether the content is an attachment or stored in a link. In case the content element is stored in a link, the processor 430 may send a request to fetch the content element, for example by downloading an image, streaming a video and the like. The system 400 also comprises a fetching unit 440 for fetching the content element from an external source, external to the user's device. The external source may be a web page in case the content is stored in a link or a mail server in case the content is an attachment file. The fetching unit 440 receives the source of the content, for example an IP address, follows the source and fetches the data. In some cases, fetching the data requires authentication, for example in accessing Flickr or a password protected folder in Dropbox.

The system 400 also comprises a content activation unit 450 for activating and displaying content, whether automatically or on user's request. For example if the content element is a video link, the video may be played when streamed responsive to the user's content gesture. Another example, if the content element is a link to a picture located in an online website, it will be displayed responsive to the user's content gesture. The content activation unit 450 can handle one of more content elements on the same time.

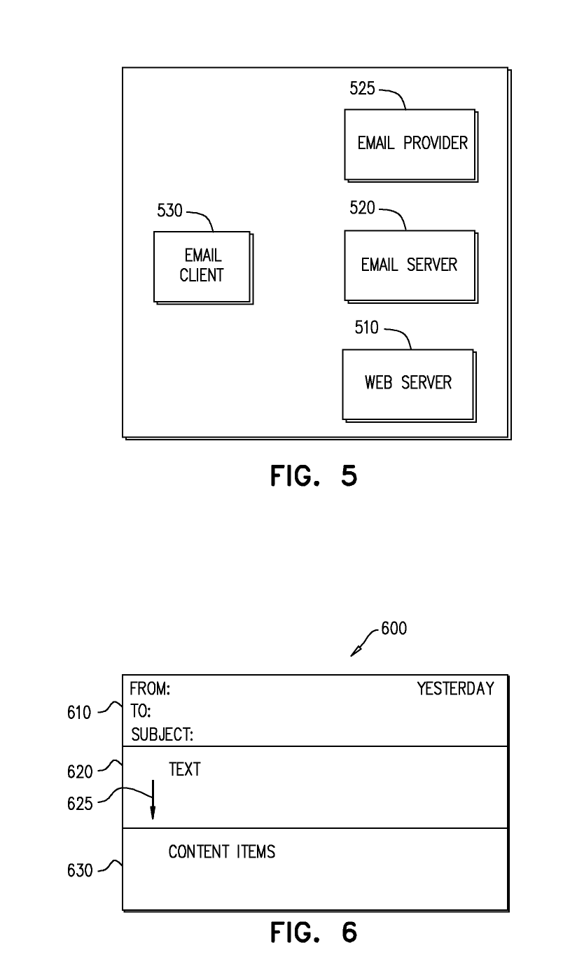

FIG. 5 shows a computerized environment for handling email messages, according to exemplary embodiments of the invention. Email client 530 is the software component installed on the user's electronic device, such as telephone, PC, tablet and the like. The user is defined as the owner of the electronic device and is also the recipient of email messages sent to an email account managed by email provider 525. The email provider may be Gmail using Gmail, Yahoo, Microsoft, AOL and the like. The email client 530 is authorized by the user of the electronic device to request receipt of all messages from the email provider 525 to be transmitted to the email client 530 via email server 520. The email server 520 receives all the email messages from the email provider and performs manipulations on at least some of the email messages as detailed below. The email messages displayed on the email client 530 are processed by the email server. For example, by reformatting the email messages, adding content items to the email messages and the like. The email client 530 comprises software application which translates data from the email server to display email messages having content items differently.

When the email server 520 identifies the email message received from the email provider 525 to include one or more content items, the email server fetches information concerning the content items and sends the information to the email client 530 along with a list of email messages displayed to the user of the electronic device associated with the email client 530. For example, when the email message comprises a link to a news website, the user will be able to review the content in the link from the email application itself using, for example, a micro browser. The user of the email client 530 inside a mobile electronic device is no longer required to use additional applications in order to view content in links.

When there are two or more items in a single link, for example a photo album or a list of video files, the email server 520 runs on the webpage of the link on a web server 510 and identifies the different content items. Then, the email server sends an indication to the email client 530 that the email message comprises two or more content items, even though the email message comprises one link only. In some exemplary cases, the email server 520 generates thumbnails representing content items of the email message. When the user of the email client opens the email message with the content items, the thumbnails will be displayed below the subject, and sometimes, also below the body of the email message. When the email message comprises both attachments and content items from links, the email server may generate a thumbnail for each of the content items found in each link.

FIG. 6 shows an email client with content items displayed under the body of the email messages, according to exemplary embodiments of the invention. The email client display 600 has at least two segments—the first segment is a header 610 of the email message. The header 610 shows the sender's details, the time in which the email message was received, the subject of the message, whether the user of the email account was designated as To of Cc field and the like. The email client display 600 also comprises a second segment for the body 620 of the email message. The body 620 comprises text sent as part of the email message. In case the received email message also comprises content items such as attachments or content from links, the content items may also be displayed while viewing the text of the body 620, for example in a third segment 630. The third segment 630 may show the content items themselves or a thumbnail that opens the content item responsive to detection of a gesture from the user of the email client. Such gesture may be to push the thumbnail upwards. In case the body 620 is long and the email message also contains content items displayed in the third segment 630, the user may reduce the size of the third segment 630 designated to the content items in order to focus on the body 620 of the email message, for example using arrow 625.

The content items of the third segment may be attachments such as images, PDF or word files, or content extracted from links such as an article from a link, several files stored in a Dropbox folder and the like. When identifying a link, the email server simulates browsing to the link and extracts the content items stored in the link. When the link includes a photo album or, a folder of files or another type of a list of content items, the email server identifies the content items and generates a specific thumbnail for each content item. The thumbnail may be a minimization of an image. The thumbnail may be an image of a link in case the link is for an article. The thumbnail may include the image and a logo of a cloud storage in which the image is stored. For example, the thumbnail may show the file's name, size, type and a logo of Google docs. When the email message contains a link to a photo album, for example in Picasa, the email client will display thumbnails of each of the images of the photo album. The user can browse the content items inside the email client application without the requirement to open the browser or use another mobile application, for example a Tweeter application, in case the link is for a twitter webpage. All the content items of the email message are shown one next to the other, under the body 620 of the email message, such that the user can see them all in a faster way. The user can view the actual content of a content item by performing a gesture on a thumbnail, which results in displaying the content itself in the mail view of the email message. Then, the user can reduce the size of the content item to a thumbnail mode, and reply to the email message, forward it, or return to the inbox.

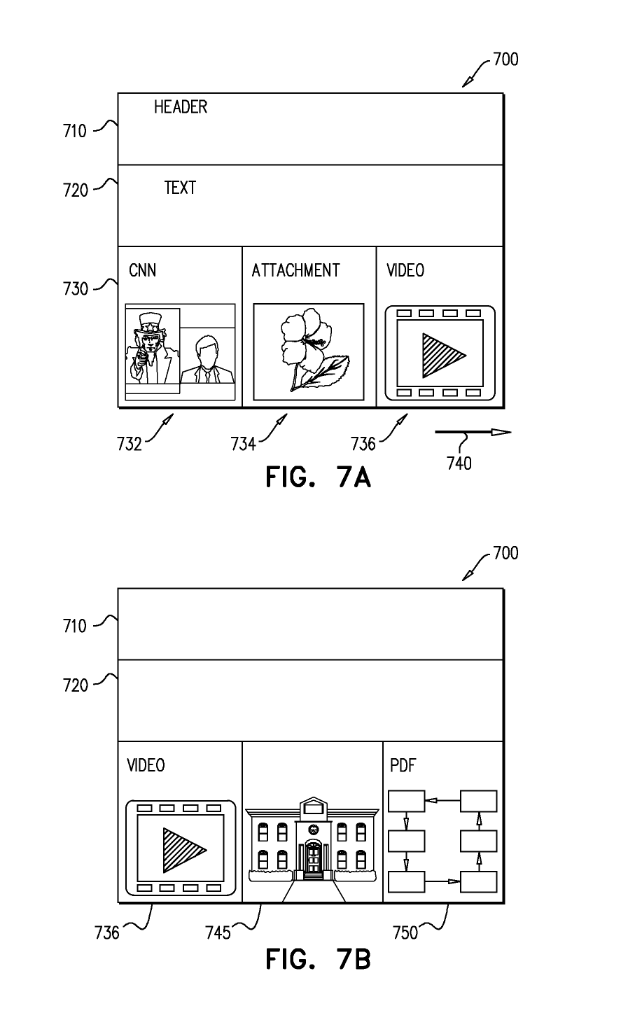

FIG. 7A-7B shows an email client with content items browsed by the user, according to exemplary embodiments of the invention. The email client display 700 has a header 710 and a body 720. In case the email message comprises content items, a third segment 730 is allocated to the display of the content items. In FIG. 7A, the three content items are displayed in the third segment 730. The three content items are displayed in a thumbnail bar in which the content items are represented in a thumbnail, and the user can browse in the content items to review them quickly and decide which of them to open. The thumbnail bar is an implementation for arranging the content icons thumbnails in a single row, which facilitates browsing and performing manipulations on the thumbnails. In some exemplary cases, the email client can display three (3) thumbnail at the same time. This number may vary according to the size of the display device, for example a tablet will show seven (7) thumbnails while a smartphone will show only three. When the email message comprises more content items, the user of the mobile email application can browse the content items in the third segment. For example, the first three content items are displayed in FIG. 7A—a link to an article from CNN.COM 732, an attachment 734 and a link to a video in vimeo.com 736. When the user of the mobile email application performs a gesture, for example by moving a thumb in the direction of arrow 740, additional content items will be displayed instead of the first three. For example, the link to vimeo.com 736 will be the left most thumbnail, while attachment 745 and a PDF file 750 will be displayed next.

The thumbnails of FIGS. 7A and 7B show various components used by the email server to generate the thumbnails, for example the logo of CNN, just the name CNN, the letters “PDF” to identify the content item as a PDF file, a house which is part of an image attachment, a face which is an image selected by an editor of CNN.COM and the like.

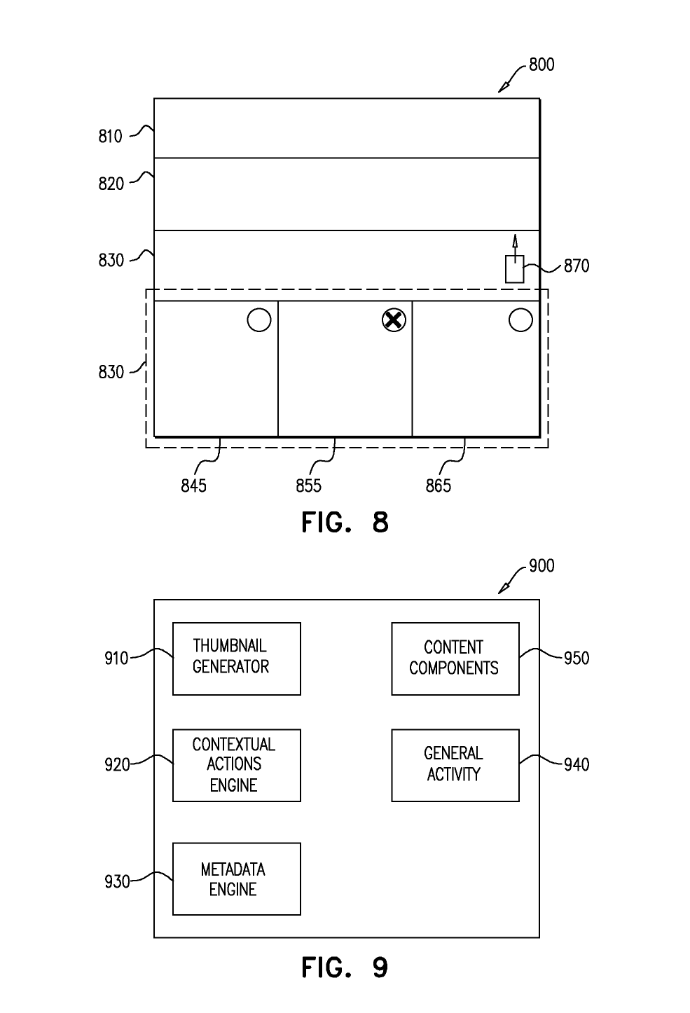

FIG. 8 shows an email client with selective actions performed on different content items of an email message, according to exemplary embodiments of the invention. The email client 400 comprises a header area 810, a body area 820, a command area 830 and a content item area 840, for displaying content items, such as attachments and content extracted from links of the received email message. The content items 845, 855 and 865 are displayed in the content item area 840. In some exemplary embodiments, at least a portion of the content items 845, 855, 865 comprise an input unit which enables the user of the email client 800 to select one or more content items of the received email message. For example, input unit 848 is used to enable the user to select content item 845, input unit 858 is used to enable the user to select content item 855, and input unit 868 is used to enable the user to select content item 865. When selecting a content item, one or more optional commands are displayed on the command area 830, for example saving the content item or sending the content item as an SMS message.

When the user of the email client 800 performs an “open” gesture on a content item of the plurality of content items, the content items is opened and viewed from inside the mobile email application. In some exemplary cases, the user can browse several content items while the content items are in “full view” mode, displayed all over the monitor of the user's electronic device. In some other cases, the user can browse between the content items while the content items are displayed in a “thumbnail mode”, below the text of the body 820.

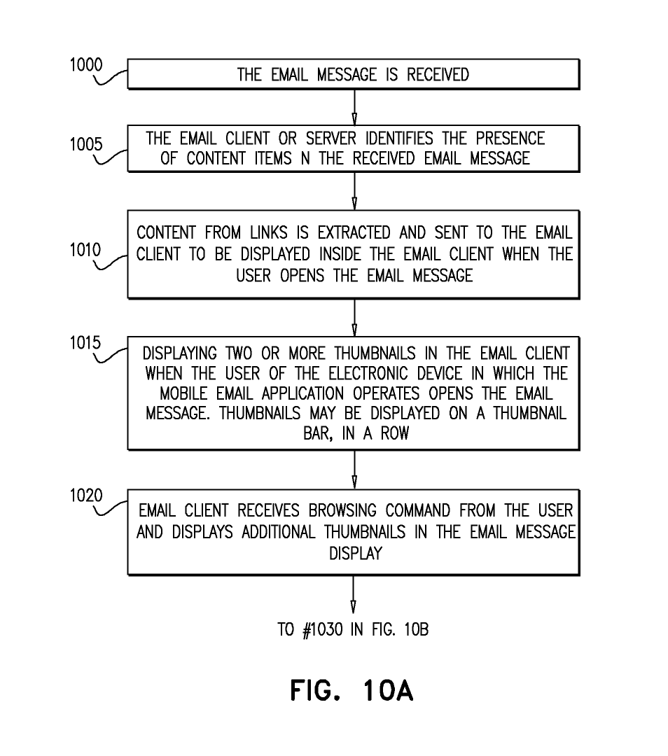

FIG. 9 shows an email server for handling email messages, according to exemplary embodiments of the invention. The server 900 comprise a thumbnail generator 910 for generating thumbnails for content items contained in email messages sent to the email client. The thumbnail may include file type in case the content item is an attachment, a minimization of an image, a logo of a service or website from which the content item is extracted and the like. For example, in case an image is from Picasa, the logo of Picas may appear in the thumbnail's corner to show the recipient of the email message that the image was extracted from Picasa. Yet, the image can be displayed from within the email mobile application as it is extracted and sent to the email client to be opened in the email mobile application. The image from a link may also be manipulated by the user of the email client, for example sent via SMS, saved, forwarded, printed and the like.

The server 900 also comprise a contextual actions engine 920 for determining contextual actions associated with a specific content item contained in a received email message. For example, when receiving an email from Facebook, there is no need to reply the email message and the user may wish to “like” an item, share it” place a comment the like. Hence, the contextual actions engine 920 identifies the content items, associates the content item with a list of potential actions and selects the relevant actions according to predefined list of rules. For example, when receiving an email message from tweeter, or from amazon, the user may confirm receipt of the product or retweet the received tweet. The contextual actions engine 920 will send the relevant contextual actions to the email client, which displays them for the user who receives the email message, for example in the command area 830.

The server 900 also comprises a metadata engine 930 which extracts metadata from the content items, such as file type, file size, file name, domain from which the content item was extracted, and the like. The metadata may be sent to the email client and improve the interface for the user when reviewing the content items. The metadata may also be used by the thumbnail generator 910 when generating the thumbnails, as the metadata may be added to at least some of the thumbnails, when necessary.

The server 900 also comprises a general email activity module 940 for managing the activities of an email server, such as sending and receiving email messages, tagging messages such as “read” or “unread”, storing statistics about the use of the email server and the like. The server 900 also comprises a content component unit 950 which extracts content from a variety of content sources, such as web pages, for example social media pages, online storage service pages and the like. The content component may contain many flags which are activated according to the content of the email messages. For example, when the email message contains a link from Amazon, the content component unit 950 extracts data from the link. The content component unit 950 may also requires specific contextual actions to be selected by the contextual actions engine 920. In some exemplary cases, the user is required to authenticate in order to access content in a specific link, for example content in Dropbox. The user may enter his credentials when downloading and activating the mobile email application, or do so once and the email client will save the credentials for the relevant web service. A single email message may contain content items aggregated from two or more content sources, such as a folder of documents in Dropbox and an article from cnn.com.

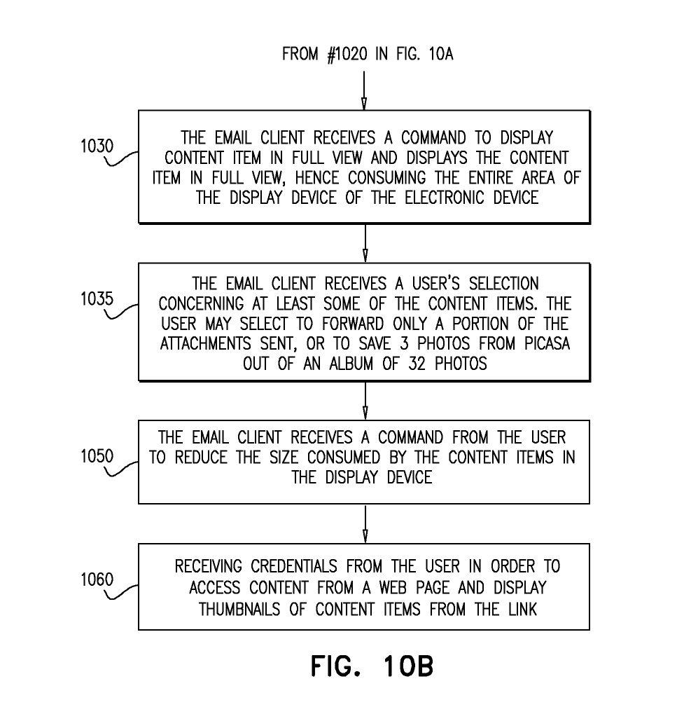

FIGS. 10A and 10B show a method for handling email messages, according to exemplary embodiments of the invention. Step 1000 discloses receiving an email message. The email message is received in a mobile email application of a user's device, for example in a tablet or smartphone. The method of the subject matter may also be implemented in a personal computer. In step 1005 the email client or email server identify the presence of content items in the received email message.

In step 1010 content from links is extracted and sent to the email client to be displayed inside the email client when the user opens the email message. Step 1015 comprises generating thumbnails associated with content items of the received email message. Step 1020 comprises displaying two or more thumbnails in the email client when the user of the electronic device in which the mobile email application operates opens the email message. The two or more thumbnails may be displayed on a thumbnail bar, in a row. In step 1025, the email client receives browsing command from the user and displays additional thumbnails in the email message display, for example in case there are many content items in the received email message. In step 1030 the email client receives a command to display content item in full view and displays the content item in full view, hence consuming the entire area of the display device of the electronic device. In step 1035, the email client receives a user's selection concerning at least some of the content items. The user may select to forward only a portion of the attachments sent, or to save 3 photos from Picasa out of an album of 32 photos.

In step 1050 the email client receives a command from the user to reduce the size consumed by the content items in the display device. Step 1060 discloses receiving credentials from the user in order to access content from a web page and display thumbnails of content items from the link

What is claimed is:

1. A method, comprising:
receiving an email message;
identifying one or more links or attachments in the received email message; and
responsive to opening the email message by a user of an electronic device, displaying two or more thumbnails representing the links or attachments in the received email message, at least one of the two or more thumbnails is associated with a link of the received email message.

2. The method of claim 1, further comprises displaying a body of the email message concurrently with displaying the two or more thumbnails.

3. The method of claim 1, further comprises displaying the content of the link inside the email client responsive to receiving a predefined display content gesture from the user.

4. The method of claim 3, further comprises downloading the content from the links responsive to receiving a predefined display content gesture from the user.

5. The method of claim 1, wherein the two or more thumbnails are displayed in a single row in a thumbnail bar.

6. The method of claim 5, further comprises decreasing the size of the thumbnail bar responsive to detecting a decreasing thumbnail bar gesture.

7. The method of claim 5, further comprises increasing the size of the thumbnail bar responsive to detecting an increasing thumbnail bar gesture.

8. The method of claim 5, further comprises displaying new thumbnails in the thumbnail bar when the user browses the thumbnail bar.

9. The method of claim 5, further comprises aggregating content from two or more links of the received email message and displaying the aggregated content from the two or more links in the thumbnail bar.

10. The method of claim 1, wherein at least two of the two or more thumbnails represent two or more content items of a single link.

11. The method of claim 1, wherein at least one of the two or more thumbnails represent content from a link of the received email message and another one of the two or more thumbnails represent content from an attachment of the received email message.

12. The method of claim 10, further comprises generating a thumbnail representing a link according to data extracted from the single link.

13. The method of claim 12, further comprises simulating browsing into the link in order to obtain the data extracted from the link.

14. The method of claim 12, wherein the thumbnail representing a link is generated in a server that handles the email message.

15. The method of claim 14, wherein the data extracted from the link is downloaded to the server that handles the email message.

16. The method of claim 1, further comprises receiving a selection command from the user with regard to one or more of the content items while displaying the received email message.

17. The method of claim 16, further comprises performing an action on the selected content items.

18. The method of claim 16, wherein suggesting and displaying a set of actions according to the type of content item and the source of the content item.

19. The method of claim 1, further comprises determining that a link represents a content item.

20. The method of claim 1, further comprises receiving credentials from the user in order to access content in a web page and display thumbnails of content items from the link after accessing the web page.
